(19) United States
(12) Patent Application Publication
(10) Pub. No.: US 2006/0010247 A1
(43) Pub. Date: Jan. 12, 2006

(54) Methods for providing communications services

(76) Inventor: Randy Zimler, Gainesville, GA (US)

Correspondence Address: SCOTT P. ZIMMERMAN, PLLC, PO BOX 3822, CARY, NC, 27519, US

(21) Appl. No.: 11/223,604

(22) Filed: Sep. 9, 2005

Related U.S. Application Data
(63) Continuation-in-part of application No. 10/743,358, filed on Dec. 22, 2003.

(51) Int. Cl. G06F 15/16; G06F 15/173

(52) U.S. Cl. 709/234; 709/239

(57) ABSTRACT

Methods, systems, and products are disclosed for providing communications services. One method receives requested data via first physical medium and a second physical medium. The second physical medium is dynamically shared amongst multiple destinations to provide additional bandwidth. The requested data is routed to a client device.

### CROSS-REFERENCE TO RELATED APPLICATIONS

This application is a continuation-in-part of U.S. application Ser. No. 10/743,358, filed Dec. 22, 2003, entitled ∓Methods of Providing Communications Services,” and incorporated herein by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to digital communications and, more particularly, to expanding bandwidth in communications systems using multiple physical mediums.

Communications customers need more bandwidth. As more and more customers utilize advanced communications services including “video-on-demand” applications, more and more data must be transmitted along twisted cable pairs, coaxial cables, fiber optic lines, and/or whatever medium is available. This video-on-demand service can require upwards of 3 megabits per second of data with a standard television format, while a High-Definition Television (HDTV) format might require a minimum of 16 megabits per second of data. A Digital Subscriber Line, however, is generally limited to a download data rate of 1.5 megabits per second. Even with advanced video compression techniques, such as ITU H.264 (MPEG 4, Part 10), Digital Subscriber Lines, coaxial cables, and even some fiber optic installations cannot provide enough bandwidth to support these advanced broadband-intensive communications services, such as the video-on-demand service. There is, accordingly, a need in the art for methods and systems of increasing the bandwidth capacity of physical mediums to support advanced broadband-intensive communications services.

### SUMMARY

The aforementioned problems, and other problems, are reduced by a methods, systems, and products for bonding additional physical mediums to increase data rates. When a communications customer requests a broadband-intensive communications service (such as downloading movies or other high-bandwidth media content), the exemplary embodiments physically and logically bond a second physical medium to provide additional bandwidth. This second physical medium is physically connected to the customer's premises, yet this second physical medium is also shared amongst other customer's premises. When the customer requires broadband-intensive communications services, the exemplary embodiments temporarily bond the second physical medium to the customer's data session to provide additional bandwidth. When the customer no longer requires the additional bandwidth, the second physical medium reverts to its shared configuration, thus allowing another customer to receive additional bandwidth when required.

Exemplary embodiments disclose a method for providing communications services. Requested data is received via first physical medium and via a second physical medium. The second physical medium is dynamically shared amongst multiple destinations to provide additional bandwidth. The requested data is routed to a client device.

Exemplary embodiments also describe a system for providing communications services. A communications module stores in memory, and a processor communicates with the memory. The processor receives requested data via first physical medium and a second physical medium. The second physical medium is dynamically shared amongst multiple destinations to provide additional bandwidth. The processor routes the requested data to a client device.

Still more exemplary embodiments describe a computer program product for providing communications services. A computer-readable medium stored a communications module, and the communications module comprises computer instructions for receiving requested data via first physical medium and a second physical medium. The second physical medium is dynamically shared amongst multiple destinations to provide additional bandwidth. The requested data is routed to a client device.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating the exemplary embodiments;

FIG. 2 is a schematic illustrating a Digital Subscriber Line (DSL) environment, according to the exemplary embodiments;

FIG. 3 is detailed schematic showing n multiple physical media, according to still more exemplary embodiments;

FIG. 4 is a block diagram showing a communications module residing in a computer system, according to the exemplary embodiments;

FIG. 5 is a flowchart illustrating a method of providing communications services, according to the exemplary embodiments;

FIG. 6 is a flowchart illustrating another method of providing communications services, according to the exemplary embodiments;

FIG. 7 is a flowchart illustrating yet another method of providing communications services, according to the exemplary embodiments;

FIG. 8 is a schematic illustrating on-demand management of bonded physical mediums, according to more exemplary embodiments;

FIG. 9 is another schematic illustrating on-demand management of bonded physical mediums, according to even more exemplary embodiments;

FIG. 10 is a schematic illustrating available bit rates, according to exemplary embodiments; and

FIGS. 11 and 12 are flowcharts illustrating another method of providing communications services, according to exemplary embodiments.

### DETAILED DESCRIPTION

The exemplary embodiments now will be described more fully hereinafter with reference to the accompanying drawings. The reader should recognize, however, that exemplary embodiments may have many different forms and should not be construed as limited to the embodiments set forth herein. These embodiments are provided so that this disclosure will be thorough and complete and will fully convey to those of ordinary skill in the art. Moreover, all statements herein reciting exemplary embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Functions may be carried out through the operation of program logic, through dedicated logic, through the interaction of program control and dedicated logic, or even manually, the particular technique being selectable by exemplary embodiments. Those of ordinary skill in the art further understand that the exemplary hardware, software, processes, methods, and/or operating systems described herein are for illustrative purposes and, thus, are not intended to be limited to any particular named manufacturer.

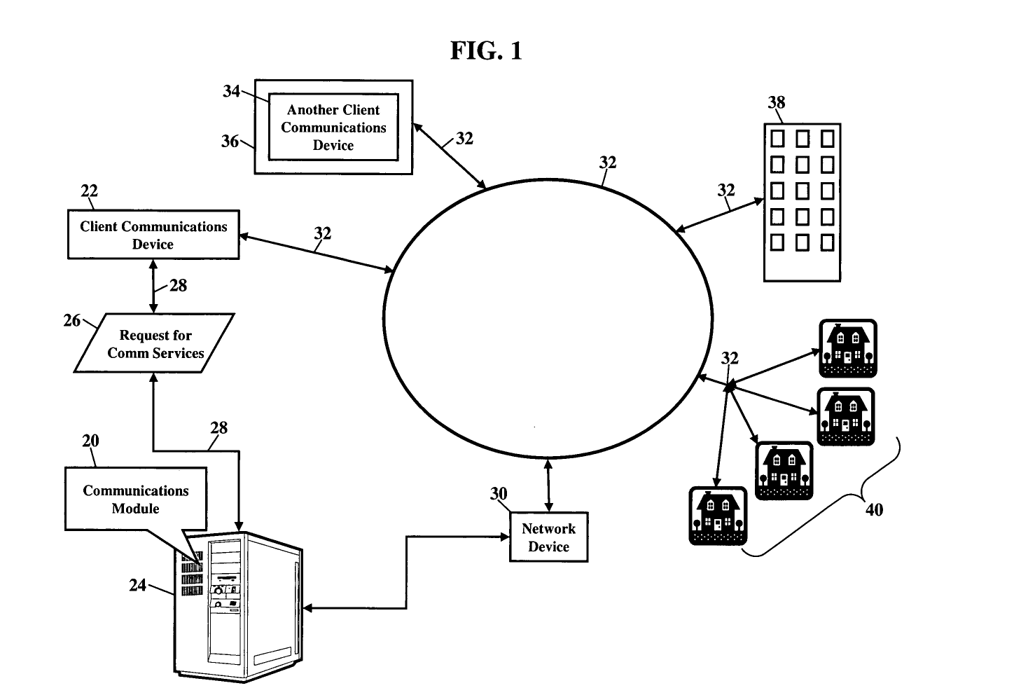

FIG. 1 is a simplified schematic illustrating the exemplary embodiments. A communications module 20 comprises methods, systems, computer programs, and/or computer program products that help provide communications services to a client communications device 22. The communications module 20 operates within a computer 24. The computer 24 receives a request 26 for communications services from the client communications device 22. When the client communications device 22 requires communications service, the term “communications service” means the client communications device 22 requests a data upload and/or a data download via a data/communications network. The term “data” includes electronic information, such as, for example, facsimile, electronic mail (e-mail), text, video, audio, and/or voice in a variety of formats, such as dual tone multi-frequency, digital, analog, and/or others. Additionally, the data may include: (1) executable programs, such as a software application, (2) an address, location, and/or other identifier of the storage location for the data, (3) integrated or otherwise combined files, and/or (4) profiles associated with configuration, authenticity, security, and others. The request 26 for communications services is received via a first physical medium 28 serving the client communications device 22. When the requested communications services exceeds the available bandwidth of the first physical medium 28, then the communications module 20 instructs a network device 30 to logically bond a second physical medium 32 to the client communications device 22. The logically bonded second physical medium 32 provides additional bandwidth to the client communications device 22.

As FIG. 1 shows, the second physical medium 32 is shared. That is, the second physical medium 32 is physically connected to the client communications device 22 and to multiple, other destinations. These other destinations may include another client communications device 34 in another customer's premises 36. The second physical medium 32 may also be shared amongst multiple destinations within an office building 38 and/or within multiple residential customers in a neighborhood 40. Even though the second physical medium 32 is shared amongst multiple destinations, the second physical medium 32 can be dynamically dedicated to a single destination when additional bandwidth is required. When the client communications device 22 requires communications services that exceed the available bandwidth of the first physical medium 28, then the shared second physical medium 32 may provide additional bandwidth. In the case where a third, fourth, or “n” number of circuits are required, additional physical media 32 can be physically and logically bonded to the client communications device 22. Data signals may then be transmitted to the client communications device 22 using the first physical medium 28, the second physical medium 32, and the “n” number of additional media. When the additional bandwidth is no longer required, the additional media reverts to its shared configuration and awaits another destination that requires additional bandwidth. In general, the terms “second physical medium” and “additional media” represent any “n” number of physical and logical connections required to terminate on the client communications device 22 in order to provide adequate bandwidth for the desired service.

The second physical medium 32 is preferably bonded to the first physical medium 28. The terms “bond,” “bonded,” “bonding,” and other similar terms means the first physical medium 28 and the second physical medium 32 share the same session of information. When the client communications device 22 requires communications services via the first physical medium 28, the communications services are provided during Point-to-Point Protocol (PPP) session of information. That is, the client communications device 22 is logically connected to the first physical medium 28. When the available bandwidth of the first physical medium 28 cannot provide the requested communications services, the second physical medium 32 shares that same session of information. The first physical medium 28 and the second physical medium 32 are physically connected to the client communications device 22 and they share a single logical connection. The communications module 20 recognizes that the second physical medium 32 is now associated with the client communications device 22. The second physical medium 32 is dynamically added in terms of the capabilities of a service at the point when the client communications device 22 requires additional bandwidth. The client communications device 22 is thus served via the first physical medium 28 and with the shared, bonded second physical medium 32.

The term “physical medium” implies a physical connection. Data signals are transmitted to/from the client communications device 22 via at least one physical connection. The first physical medium 28 and the second physical medium 32 may both be a twisted copper pair of wires, as is commonly found throughout many communications networks (such as the Public Switched Telephone Network). The first physical medium 28 and the second physical medium 32, however, may also include coaxial cable and/or fiber optic cable. The first physical medium 28 and second physical medium 32 may even include at least one of i) a combination of a twisted pair and a coaxial cable, ii) a combination of a twisted pair and a fiber optic cable, and iii) a combination of a coaxial cable and a fiber optic cable.

The network device 30 bonds the second physical medium 32. When the available bandwidth of the first physical medium 28 is exceeded, the communications module 20 instructs the network device 30 to logically bond the second physical medium 32 to the client communications device 22. The logically bonded second physical medium 32 provides additional bandwidth to the client communications device 22. The network device 30 can be a computing device that can execute instructions from the communications module 20. Some examples of the network device 30 may include an internet server, a content server, a gateway, a switch, a multiplexer, a modem, or any other device that can logically bond additional bandwidth.

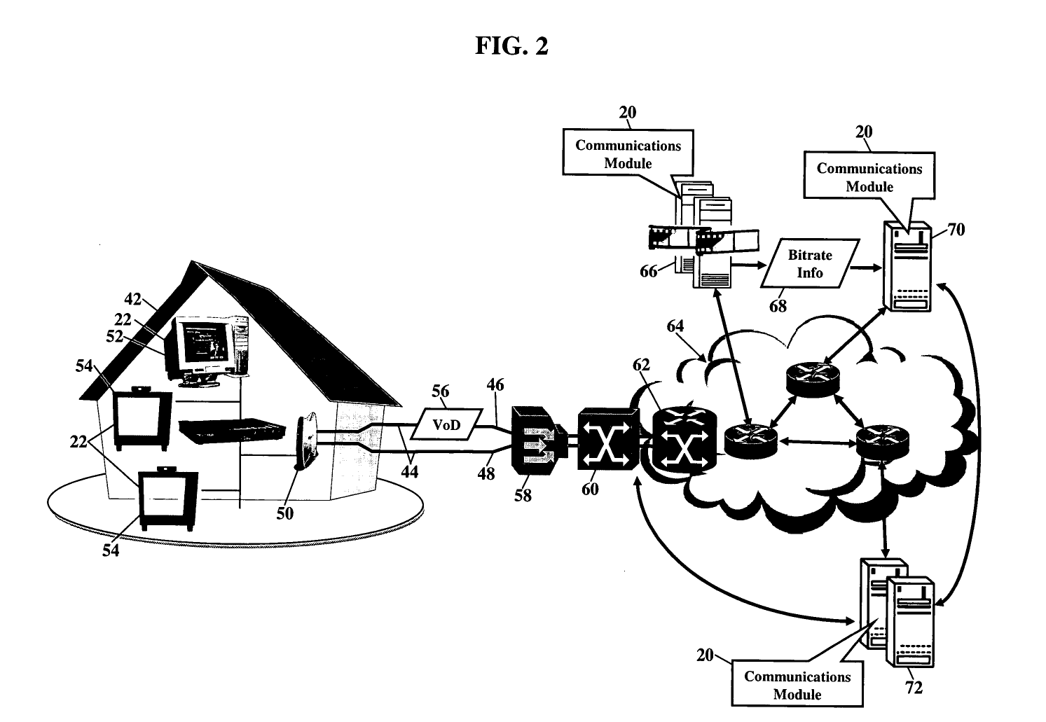

The exemplary embodiments are further illustrated by the following non-limiting example. FIG. 2 is a detailed schematic applying the exemplary embodiments in a Digital Subscriber Line (DSL) environment. As those of ordinary skill in the art understand, DSL uses twisted pair transmission lines to transmit high-bandwidth, high frequency signals. DSL is a transport medium for signals along a single twisted-wire pair. This twisted wire pair supports both Message Telecommunications Service (e.g., Plain Old Telephone Service), full-duplex (simultaneous two-way), and simplex (from the network to a customer's installation) digital services. Because DSL is commonly available to residential customers and to business customers, this patent will not further discuss DSL technology. If, however, the reader desires more information on DSL technology, the reader is invited to consult AMERICAN NATIONAL STANDARDS INSTITUTE, Network to Customer Installation Interfaces—Asymmetric Digital Subscriber Line (ADSL) Metallic Interface (ANSI T1.413-1998) (1819 L Street NW, Washington, DC 20036, (202) 293-8020, www.ansi.org), and incorporated herein by reference in its entirety.

FIG. 2 shows a customer's premises 42. The customer's premises 42 are served by multiple physical media 44, such as a first twisted pair 46 and a second twisted pair 48. The multiple physical media 44 are shown connected to a residential gateway 50, such as a DSL modem, cable modem, router, or other access device. The residential gateway 50 provides an access interface to one or more of the customer's client communications devices 22. The customer may have multiple client communications devices 22 communicating via a home network with the residential gateway 50. FIG. 2, for example, shows the multiple client communications devices 22 as a computer 52 and one or more digital television devices 54 (including a television set-top box (STB)). The client communications devices 22, of course, could also include other computer devices (such as a laptop, desktop, tablet, server, and other computer systems), a personal digital assistant (PDA), a Global Positioning System (GPS) device, an Internet Protocol (EP) phone, a pager, a cellular/satellite phone, a modem, or any computer/communications device utilizing a digital signal processor (DSP).

The customer's client communications devices 22 requests communications services via the first twisted pair 46. Assume, for example, that one of the digital television devices 54 requests a download of video data (e.g., a video-on-demand service). A video-on-demand (VoD) request 56 is communicated via the first twisted pair 46 through a Digital Subscriber Line Access Multiplexer 58, through an asynchronous transfer mode (ATM) switch 60, through a broadband gateway 62, and into a primary ATM network 64. The video-on-demand request 56 routes along the ATM network 64 to the communications module 20 operating in the ATM network 64. FIG. 2 shows the communications module 20 operating in multiple computer devices within the ATM network 64, although those of ordinary skill in the art understand the communications module 20 may operate within a single computer device. The communications module 20 compares the bandwidth required to provide the requested video-on-demand service and the available bandwidth along the first twisted pair 46. The communications module 20 thus determines whether enough bandwidth is available to deliver the requested video over the first twisted pair 46 (e.g., a single DSL connection).

The video-on-demand request 56 routes along the ATM network 64 to a content server 66. This content server 66 may store some, or all, of the requested video data. The content server 66 determines the bitrate of the requested video data (e.g., 5 megabits per second of video data). The content server 66 then sends bitrate information 68 to a web server/service control computer device 70. If the available bandwidth is inadequate for a Quality of Presentation objective, the communications module 20 instructs a radius cluster 72 to arrange adequate bandwidth. The radius cluster 72 observes the configuration of the first twisted pair 46 and the configuration of the second, shared twisted pair 74. The radius cluster 72 then instructs the Digital Subscriber Line Access Multiplexer (DSLAM) 58 to establish physical bonding with the second twisted pair 48. The radius cluster 72 also instructs the Digital Subscriber Line Access Multiplexer 58 to establish logical bonding of the Point-to-Point Protocol (PPP) session of information. The radius cluster 72 manages the logic on the broadband gateway 62, thus instructing the Digital Subscriber Line Access Multiplexer 58 to enable the bonding. Once the second twisted pair 48 is physically and logically bonded, the content server 66 may then transmit/deliver the requested video data content to the digital television device 54 via the Internet Protocol (IP) network 64. The physically and logically bonded second twisted pair 48 provides additional bandwidth to the digital television device 54. When the additional bandwidth is no longer required, the radius cluster 72 instructs the Digital Subscriber Line Access Multiplexer 58 to terminate the physical bonding and the logical bonding, thus reverting the second twisted pair 48 to its shared configuration.

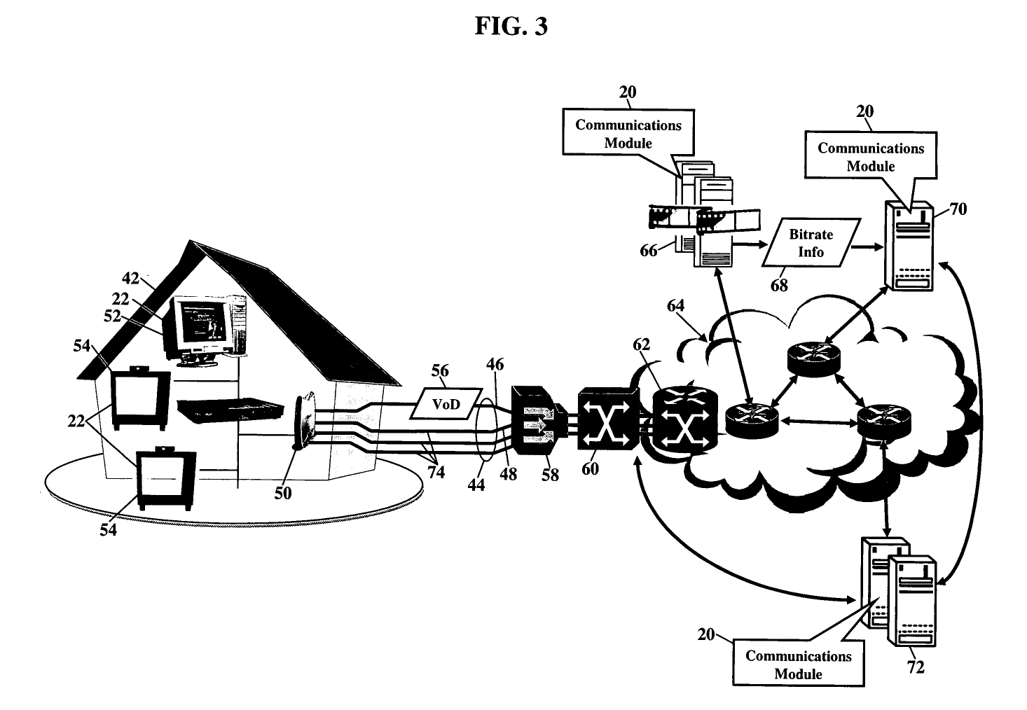

FIG. 3 is another detailed schematic applying the exemplary embodiments in a Digital Subscriber Line (DSL) environment. FIG. 3 is very similar to FIG. 2, except here the customer's premises 42 are served by n multiple physical media 44. That is, the when the requested communications service exceeds the available bandwidth of a primary twisted pair (such as the first twisted pair 46), the communications module 20 instructs the radius cluster 72 to arrange additional bandwidth. The radius cluster 72 again observes the configuration of the primary twisted pair. Here, however, the radius cluster 72 may observe the configuration of n multiple shared twisted pairs 74, where n denotes any integer. The radius cluster 72 can instruct the Digital Subscriber Line Access Multiplexer 58 to dynamically establish physical and logical bonding with n multiple shared twisted pairs 74. These n multiple shared twisted pairs 74 provide n bonded PPP sessions to dynamically provide as much bandwidth as the customer might require. Once the additional bandwidth is no longer required, the radius cluster 72 reverts the n multiple shared twisted pairs 74 to their shared configuration.

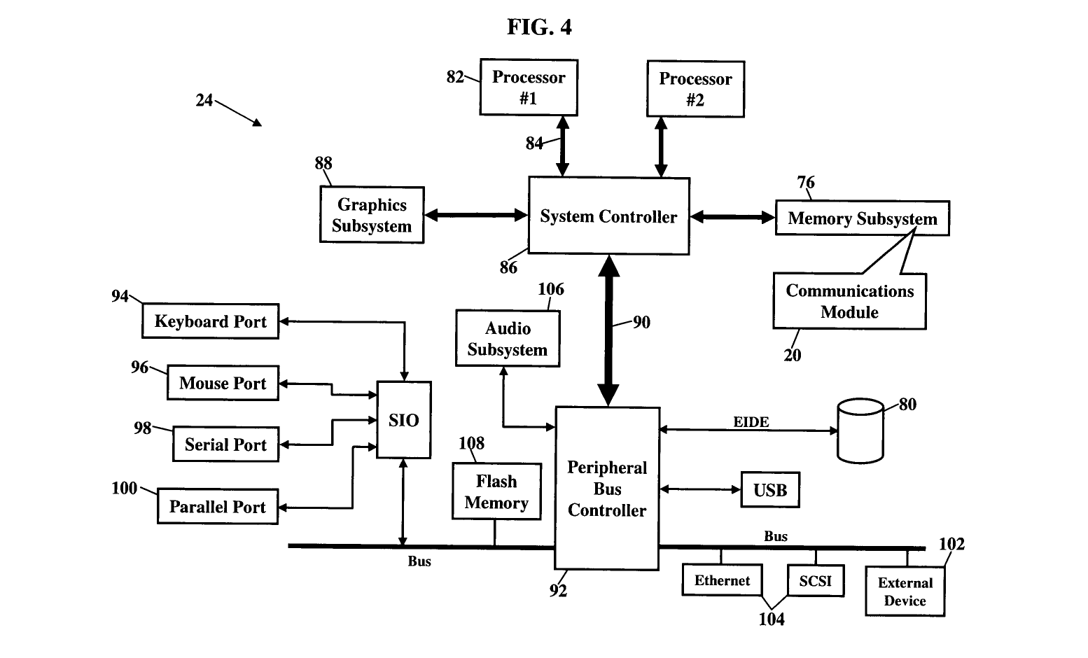

FIG. 4 is a block diagram showing the communications module 20 residing in the computer system 24. The computer system 24 may be any computing device, and the computer system 24 may include the content server, the web server/service control computer device, and the radius cluster (shown, respectively, as reference numerals 66, 70, and 72 in FIGS. 2 and 3). The communications module 20 operates within a system memory device. The communications module 20, for example, is shown residing in a memory subsystem 76. The communications module 20, however, could also reside in flash memory 78 or peripheral storage device 80. The computer system 24 also has one or more central processors 82 executing an operating system. The operating system, as is well known, has a set of instructions that control the internal functions of the computer system 24. A system bus 84 communicates signals, such as data signals, control signals, and address signals, between the central processor 82 and a system controller 86 (typically called a “Northbridge”). The system controller 86 provides a bridging function between the one or more central processors 82, a graphics subsystem 88, the memory subsystem 76, and a PCI (Peripheral Controller Interface) bus 90. The PCI bus 90 is controlled by a Peripheral Bus Controller 92. The Peripheral Bus Controller 92 (typically called a “Southbridge”) is an integrated circuit that serves as an input/output hub for various peripheral ports. These peripheral ports are shown including a keyboard port 94, a mouse port 96, a serial port 98 and/or a parallel port 100 for a video display unit, one or more external device ports 102, and networking ports 104 (such as SCSI or Ethernet). The Peripheral Bus Controller 92 also includes an audio subsystem 106. Those of ordinary skill in the art understand that the program, processes, methods, and systems described in this patent are not limited to any particular computer system or computer hardware.

Those of ordinary skill in the art also understand the central processor 82 is typically a microprocessor. Advanced Micro Devices, Inc., for example, manufactures a full line of ATHLON™ microprocessors (ATHLON™ is a trademark of Advanced Micro Devices, Inc., One AME Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 76, flash memory 108, or peripheral storage device 80) may also contain an application program. The application program cooperates with the operating system and with a video display unit (via the serial port 98 and/or the parallel port 100) to provide a Graphical User Interface (GUI). The Graphical User Interface typically includes a combination of signals communicated along the keyboard port 94 and the mouse port 96. The Graphical User Interface provides a convenient visual and/or audible interface with a user of the computer system 24.

The exemplary embodiments may be applied to other environments. When requested communications services exceed the available bandwidth of a primary first physical medium serving a customer's premises, and/or a client communications device, the exemplary embodiments physically and logically bond n multiple, additional physical mediums. The bonded n multiple, additional physical mediums provide additional bandwidth when necessary. Because the term “physical medium” implies a physical connection, the exemplary embodiments are not limited to Digital Subscriber Line environments. The exemplary embodiments may be applied to a generic physical infrastructure, such as a fiber plant, a copper plant, a coaxial cable plant, and hybrid versions/combinations of each. Because the exemplary embodiments may be applied to other physical infrastructures, these other physical infrastructures need not require the Digital Subscriber Line Access Multiplexer, the asynchronous transfer mode (ATM) switch, and the broadband gateway (shown, respectively, as reference numerals 58, 60, and 62 in FIGS. 2 and 3). These other physical infrastructures may require additional and/or alternative equipment, as those of ordinary skill in the art will recognize.

The exemplary embodiments, for example, could be applied to the coaxial cable industry. Whereas FIGS. 2 and 3 show the customer's premises 42 being served by n multiple twisted pairs, the customer's premises could be served by n multiple coaxial cables. These n multiple coaxial cables would be the multiple physical media providing media content to the customer's premises 42. When the customer's requested communications services exceed the available bandwidth of a primary coaxial cable serving a customer's premises, and/or a client communications device, then the exemplary embodiments physically and logically bond n multiple, additional coaxial cables. The logically bonded n multiple, additional coaxial cables provide additional bandwidth when necessary. While there are many devices used within the coaxial cable infrastructure that could physically/logically bond the n multiple, additional coaxial cables, a cable modem termination system (CMTS) is one example.

The exemplary embodiments may also be applied to a fiber optic infrastructure. Because the cost of an all-fiber infrastructure is expensive, and because a fiber optic media can transmit/transport much more information/signals, one or more shared fiber optic lines could be more economically feasible. A customer's premises could be served by n multiple fiber optic lines, and these fiber optic lines could also be shared by other customers. When one customer's requested communications services exceed the available bandwidth of a primary physical media (such as a DSL, a coaxial cable, and/or a fiber optic line), then the exemplary embodiments could physically and logically bond one or more fiber optic lines to the customer's session. The logically bonded fiber optic lines provide additional bandwidth when necessary. This fiber infrastructure, for example, might utilize an Optical Network Unit (ONU) to physically/logically bond one or more fiber optic lines to the customer's session.

The exemplary embodiments provide added benefits. Because the customer's premises are served by multiple physical media, these shared media provide redundancy. As the years pass, the physical and performance properties of the physical media may degrade. Because, however, the customer has access to multiple physical media, the exemplary embodiments provide greater statistical probabilities for successful transmissions of data signals. Because the customer, again, has access to multiple physical media, there is less of a chance that the customer will lose all communications service during storms and catastrophes. Should one of the physical mediums be severed or disabled, the other physical media provide redundant communications paths.

The exemplary embodiments provide still more benefits. Because the exemplary embodiments utilize multiple physical mediums, each individual medium could be dedicated to a particular format. The primary physical medium, for example, might be dedicated to a specific service (such as standard Internet traffic) and/or a particular range of frequencies. An additional, shared medium might be reserved for higher bandwidth requirements (such as MPEG1/2/3/4 content) and/or higher frequency signals.

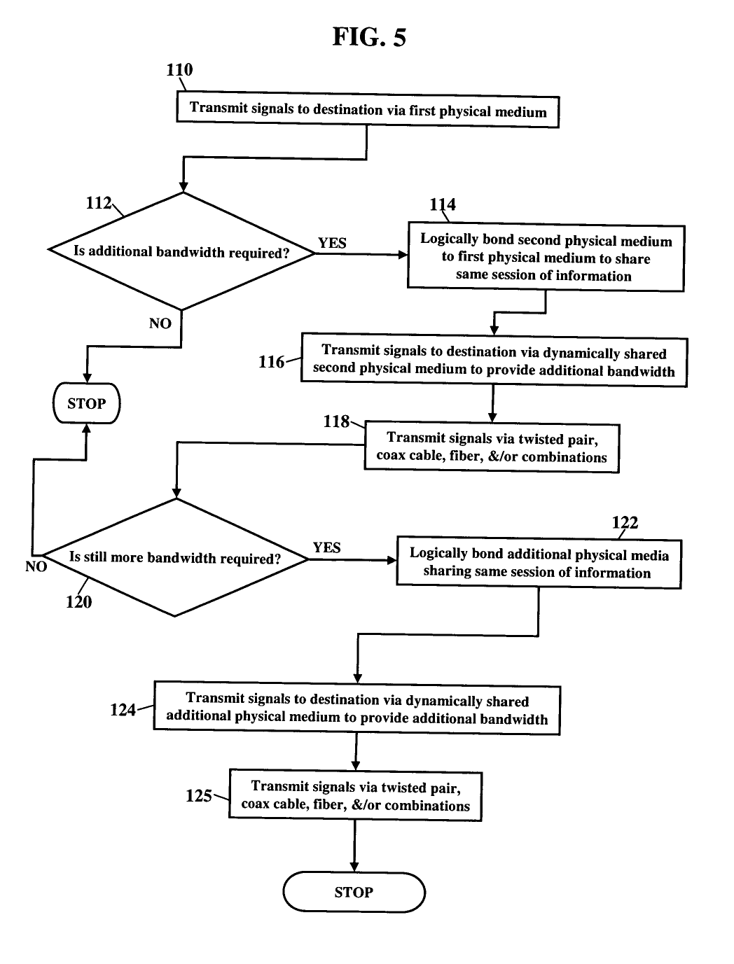

FIG. 5 is a flowchart illustrating a method of providing communications services, according to the exemplary embodiments. Signals are transmitted to a destination via a first physical medium (Block 110). If additional bandwidth is required (Block 112), a second physical medium is logically bonded to the first physical medium (Block 114), such that first physical medium and the second physical medium share the same session of information. Signals are then transmitted to the destination via the second physical medium (Block 116). The second physical medium is dynamically shared amongst multiple destinations to provide additional bandwidth when required. Signals may be transmitted via a twisted pair, via a coaxial cable, via a fiber optic cable, and/or via hybrid combinations, such as i) a combination of a twisted pair and a coaxial cable, ii) a combination of a twisted pair and a fiber optic cable, and iii) a combination of a coaxial cable and a fiber optic cable (Block 118). If additional bandwidth is still required (Block 120), additional physical media can be logically bonded (Block 122). Each additional physical media is dynamically shared amongst the multiple destinations to provide additional bandwidth. Signals are then transmitted to the destination via the first physical medium and the second physical medium, thus sharing the same session of information (Block 124). When the signals are transmitted to the destination, the signals may be transmitted via twisted pair, coaxial cable, fiber optic cable, and hybrid combinations (Block 125).

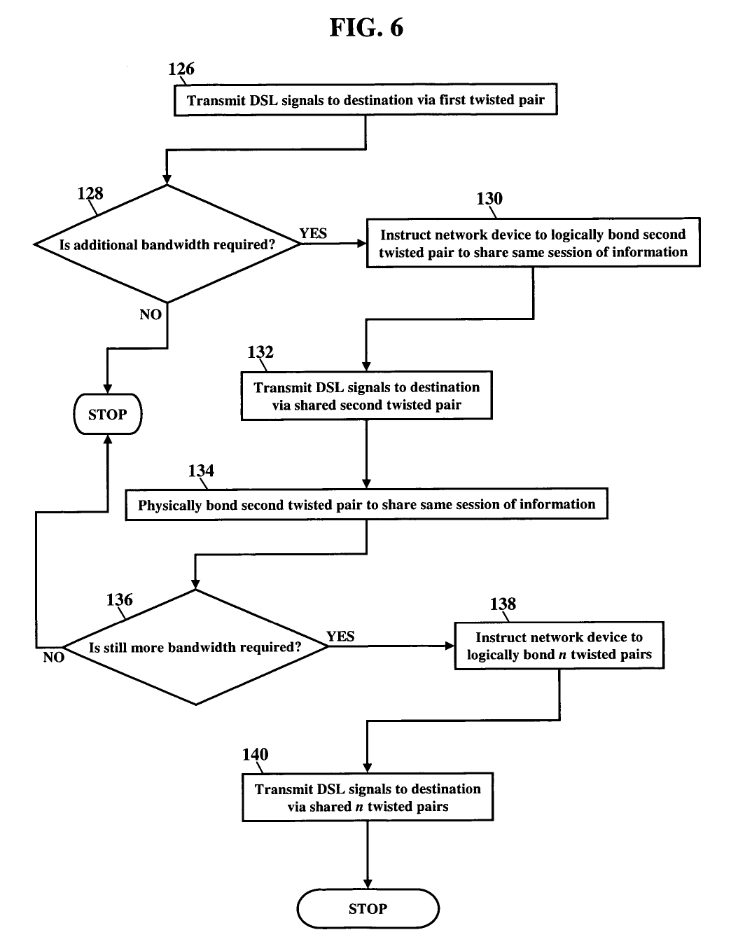

FIG. 6 is a flowchart illustrating another method of providing communications services. Digital Subscriber Line (DSL) signals are transmitted to a destination via a first twisted pair (Block 126). If additional bandwidth is required (Block 128), a network device is instructed to logically bond a second twisted pair and the first twisted pair (Block 130), such that first twisted pair and the second twisted pair share the same session of information. Digital Subscriber Line signals are then transmitted to the destination via the second twisted pair (Block 132). The second twisted pair is shared amongst the destination and another destination, and the second twisted pair provides additional bandwidth when required. The second twisted pair may be physically bonded to the first twisted pair (Block 134), such that first twisted pair and the second twisted pair share the same session of information. If additional bandwidth is still required (Block 136), the network device is instructed to logically bond a third twisted pair to the destination (Block 138). The third twisted pair is shared amongst the destination and another destination, and the third twisted pair provides additional bandwidth when required. If additional bandwidth is still required (Block 140), the network device is instructed to logically bond n additional twisted pairs to the destination (Block 142). The n additional twisted pairs are shared amongst the destination and another destination, and the n additional twisted pairs provide additional bandwidth when required. Digital Subscriber Line signals are then transmitted to the destination via the twisted pairs (Block 144).

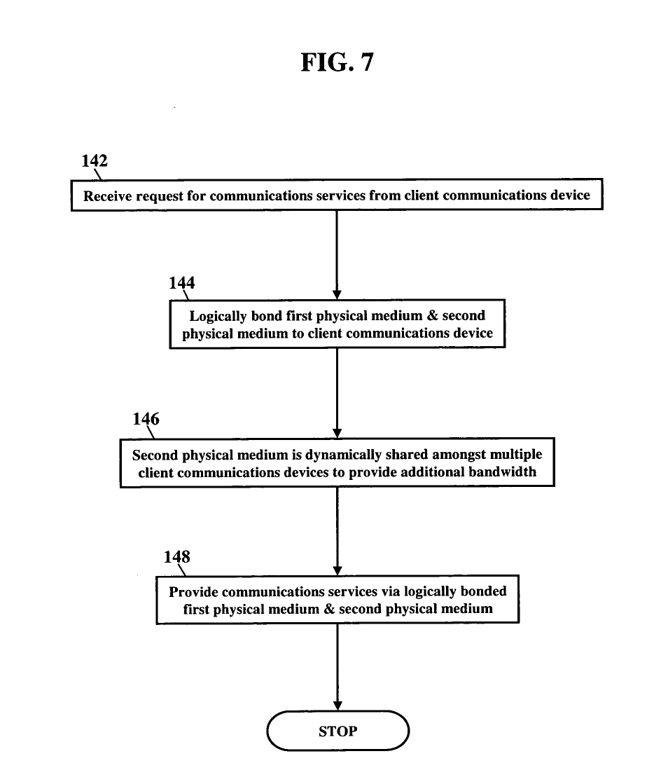

FIG. 7 is a flowchart illustrating yet another method of providing communications services. A request for communications services is received from a client communications device (Block 142). A first physical medium and a second physical medium are logically bonded to the client communications device (Block 144). The second physical medium is dynamically shared amongst multiple client communications devices to provide additional bandwidth when required (Block 146). The communications services are then provided via the logically bonded first physical medium and the second physical medium (Block 148).

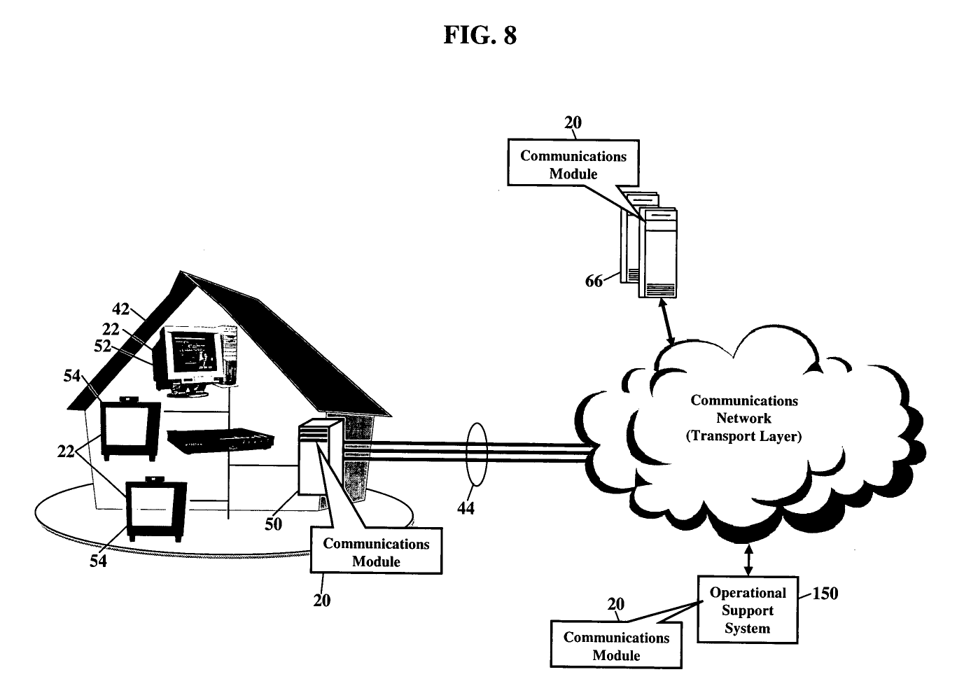

FIG. 8 is a schematic illustrating on-demand management of bonded physical mediums, according to more exemplary embodiments. Regardless of how many physical mediums may serve the client communications devices 22 (or any destination), the logical bonding of those physical mediums must be managed. Here, then, the communications module 20 also provides a feedback mechanism. This feedback mechanism monitors when requested bit rates exceed currently available bit rates. When a customer's requested content or programming requires a greater bit rate than can be provided, the feedback mechanism informs the customer of this discrepancy. The feedback mechanism may also provide the customer with alternatives that remain within the capabilities of the communications network.

FIG. 8 illustrates this feedback mechanism. Here some portions of the communications module 20 operate within the client communications device 22 (such as the residential gateway 50), other portions may operate within an operational support system 150 for the multiple physical mediums 44, and some other portions may operate in the content server 66. The communications module 20 monitors requested bit rates and compares the requested bit rates to available bit rates. When a customer requests programming or content, the communications module 20 arbitrates between the capabilities of the physical mediums 44, the operational support system 150, and the residential gateway 50 to provide that requested bit rate. Should the requested bit rate exceed the available bit rate, then the communications module 20 may provide alternatives.

An example helps explain this feedback mechanism. Suppose some testing shows the customer may receive five megabits per second (5 Mb/s) of data. Regardless of how many multiple physical mediums 44 that may be available at that customer's premises 42, current network conditions limit the customer to 5 Mb/s. When the customer decides to view a channel of programming or content, the operational support system 150 communicates with the content server 66 (or head end server, depending on the network infrastructure or terminology). The operational support system 150 informs the content server 66 of the customer's 5 Mb/s limit. If, for example, the DISCOVERY CHANNEL© requires less than or equal to 5 Mb/s, then the content server 66 is authorized to provide that channel or content (DISCOVERY CHANNEL is a copyright of Discovery Communications, Inc.). If the customer then chooses another channel that requires 6 Mb/s, this bit rate exceeds the current limit (e.g., 5 Mb/s). The communications module 20 knows that the multiple physical mediums 44 cannot provide enough bandwidth to support this channel/content. This feedback mechanism, then, informs the customer of bottlenecks that restrict service.

The communications module 20 may present alternatives. Because the customer's requested bit rate cannot be supported, the communications module 20 may prompt the customer to select another channel or other content. The prompt would be audibly and/or visually presented on the client communications device 22 (such as the computer 52 or the television 54). The communications module 20 may even present channel/content alternatives that do not exceed the current bit rate limit. The communications module 20 may also prompt the customer to reduce current bandwidth usage. If the customer has multiple televisions 54 or other devices receiving data, and thus consuming bandwidth, the communications module 20 may visually and/or audibly prompt the customer to terminate one of these sessions. The communications module 20 may inform the customer of these multiple sessions by graphically illustrating the customer's bandwidth usage. This feedback mechanism provides the customer with options and allows the customer to make an informed decision. If the customer has no options, the communications module will state so.

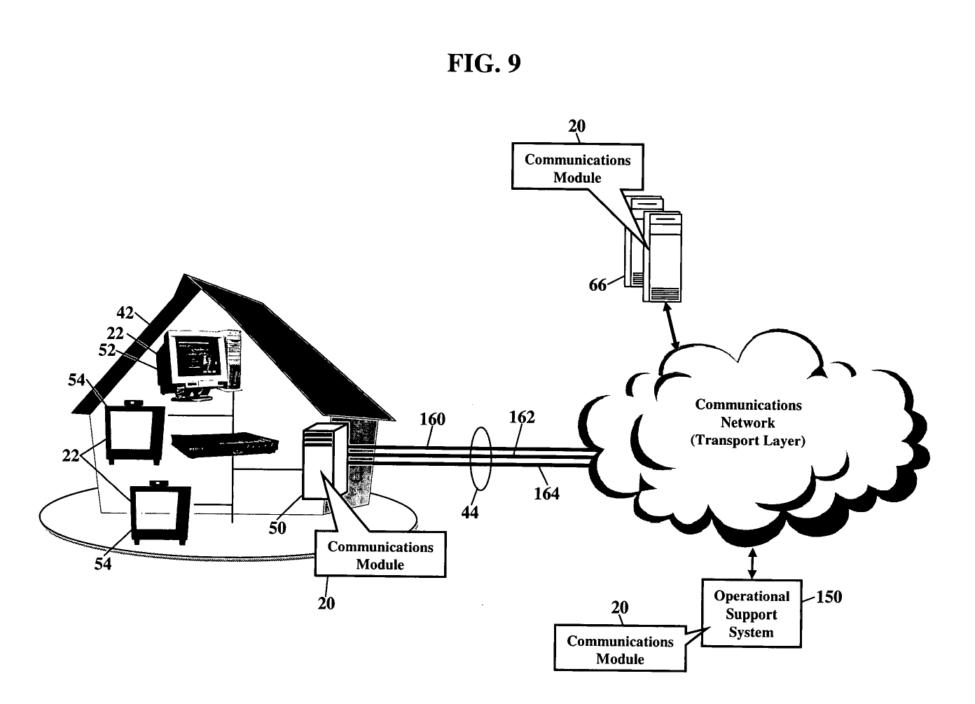

FIG. 9 is another schematic illustrating on-demand management of bonded physical mediums, according to even more exemplary embodiments. Here the customer's premises 42 are served by three (3) physical mediums 44. The operational support system 150 for the multiple physical mediums 44 knows the total bandwidth currently available for the three (3) physical mediums 44. Suppose a first physical medium 160 supports twelve megabits per second (12 MB/s). No matter how much content is requested, no matter how many channels are requested, the first physical medium 160 is only able to provide a total of 12 MB/s. Likewise, suppose a second physical medium 162 may also provide a maximum of 12 Mb/s, thus allowing the residential gateway 50 to receive a total of 24 Mb/s. However the residential gateway 50 “carves” this bandwidth amongst the multiple client communications devices 22 operating within the premises 42, those client communications devices 22 share the 24 Mb/s. When a third physical medium 164 is bonded, suppose the maximum bit rate increases to 30 Mb/s (that is, the third physical medium 164 provides 6 Mb/s). Whatever content/channels are requested, the three (3) bonded physical mediums 44 may support a maximum of 30 Mb/s.

The communications module 20 arbitrates between the content server 66, the operational support system 150, and the residential gateway 50. The communications module 20 decides what content or channels is communicated via the first physical medium 160, what content/channels are sent via the second physical medium 162, and what content/channels are sent via the third physical medium 164. Suppose, for example, the communications module 20 decides to send channels 1, 2, and 3 down the first physical medium 160, while channels 4, 5, and 6 are sent along the second physical medium 162. Once all that data is received at the residential gateway 50, the communications module 20 (operating in the residential gateway 50) determines how all that information is split, carved, or disbanded amongst multiple client communications devices 22 operating within the premises 42. One television device 54, for example, may tuned to channel 1, so the communications module 20 (operating in the residential gateway 50) pulls channel 1 from the first physical medium 160 and routes that information to the television device 54. If channel 5 was requested by another client communications device 22 operating in the kids' room, then the communications module 20 pulls channel 5 from the second physical medium 162 and routes that data to the kids' room (via the home network). The communications module 20 acts as a broadband interface between the customer, the communications network (e.g., the multiple physical mediums 44), the operational support system 150, and the content server 66 to determine how all that content or all those channels may be managed. The communications module 20 also manages which broadband interface (e.g., which physical medium) transports what channels to the customer's residential gateway 50. The communications module 20 then manages how all that content or channels is distributed throughout the customer's premises 42.

The type of physical medium is not important. The physical medium(s) may be any physical connection that carries data. The physical medium(s) may be twisted copper pairs, coaxial cable, and/or fiber optic cable. The physical medium(s) may even include a combination of a twisted pair and a coaxial cable, a combination of a twisted pair and a fiber optic cable, and/or a combination of a coaxial cable and a fiber optic cable. The physical mediums may even have wireless components operating on any portion of the electromagnetic spectrum and utilizing any signaling standard (such as the I.E.E.E. 802 family of standards). Whatever the physical medium, the communications module 20 determines how data transported along those physical mediums is moved throughout the customer's premises 42.

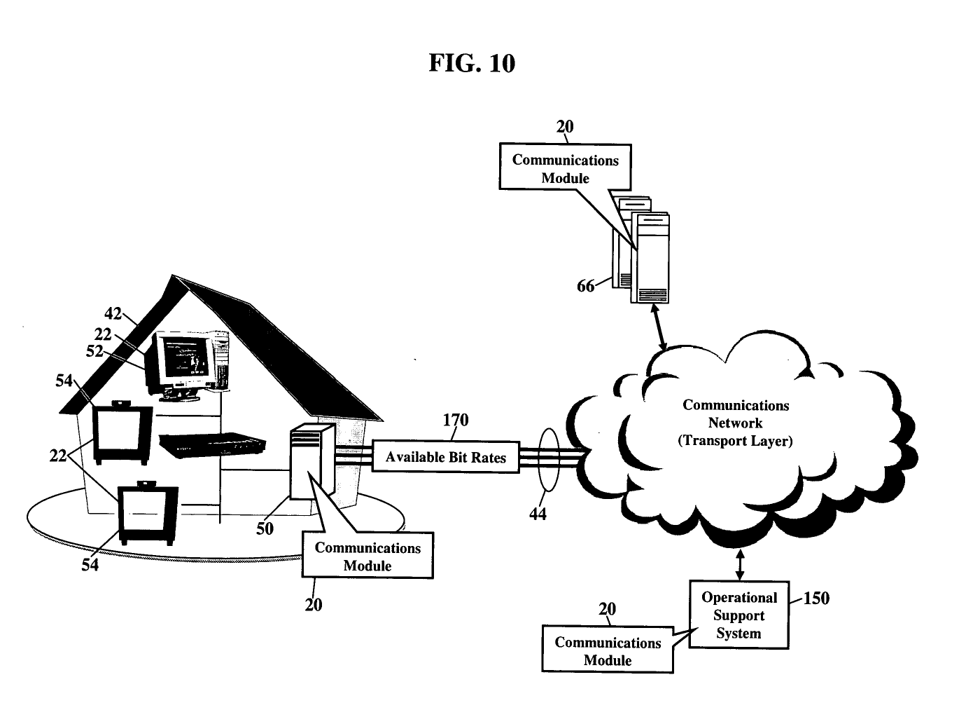

FIG. 10 is a schematic illustrating available bit rates, according to exemplary embodiments. The communications module 20, as earlier described, provides a feedback mechanism. This feedback mechanism monitors when requested bit rates exceed currently available bit rates. When a customer's requested content or programming requires a greater bit rate than can be provided, the feedback mechanism informs the customer of this discrepancy. The feedback mechanism may also provide the customer with alternatives that remain within the capabilities of the communications network.

FIG. 10, then, illustrates a determination of currently available bit rates. When the residential gateway 50 communicates with the operational support system 150, a bit rate is negotiated for each physical medium 44. Each available bit rate 170 may be determined when the residential gateway 50 is first powered “on” and establishes a synchronization rate with the operational support system 150. The available bit rate 170, additionally, may be determined at any time when requested. The available bit rate 170 could be a part of a video service, some other service, or the negotiated bit rate may be a stand alone determination. The available bit rate 170 may be part of a broadband management system. A resynchronization operation may also be used, but, resynchronization may disrupt, or even terminate, service, which would interrupt delivery of content or channels. However the currently available bit rate is determined, that bit rate is pushed through the communications network to the operational support system 150 and to the content server 66 in order to manage that knowledge base.

The available bit rate 170 may be periodically and/or randomly re-evaluated. The available bit rate 170, as above described, may be determined when the residential gateway 50 powers “on” and establishes a synchronization rate with the operational support system 150. Whatever that maximum synchronization rate may be, over time the connection quality may degrade. Sometimes the maximum synchronization rate shifts a little because of noise scenarios. So the communications module 20 may periodically and/or randomly verify that maximum synchronization rate. The communications module 20 may or may not renegotiate the maximum synchronization rate. If the maximum synchronization should decrease, that decrease is pushed back to the operational support system 150. The operational support system 150 then passes that information to the content server 66, video service platform, or other provider. The content server 66 is now updated with the latest currently available bit rate. The communications module 20 may periodically and/or randomly re-evaluate the available bit rate and update the operational support system 150.

A re-evaluation of the available bit rate may be conditionally triggered. That is, the communications module 20 may include configurable conditions that initiate re-evaluation. Initialization of a client communications device 22, for example, may trigger a re-evaluation. As each client communications device 22 is added to the customer's home network, the communications module 20 evaluates the available bit rate 170. The communications module 20 may be configured to evaluate the available bit rate according to a time schedule, such as every thirty (30) minutes or any other interval. Each channel change or content request may initiate a re-evaluation. The available bit rate 170 may be evaluated according to a bit/byte schedule, such that the after a predetermined number of bits/bytes is sent or received, the available bit rate 170 is evaluated.

The available bit rate 170 may be determined according to packet transfer rates. Packets of data are sent to a destination, and response packets are received. Based on the data transfer rate, the available bit rate 170 is known. A determination of transfer rates is less disruptive to the customer's service. Again, however the currently available bit rate is determined, the objective may be a minimal disruption of service when verifying bit rates.

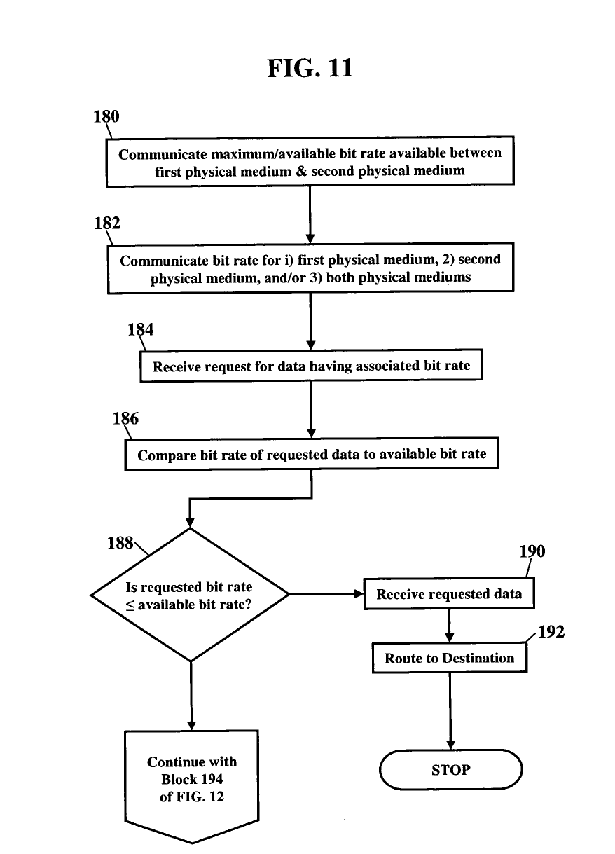

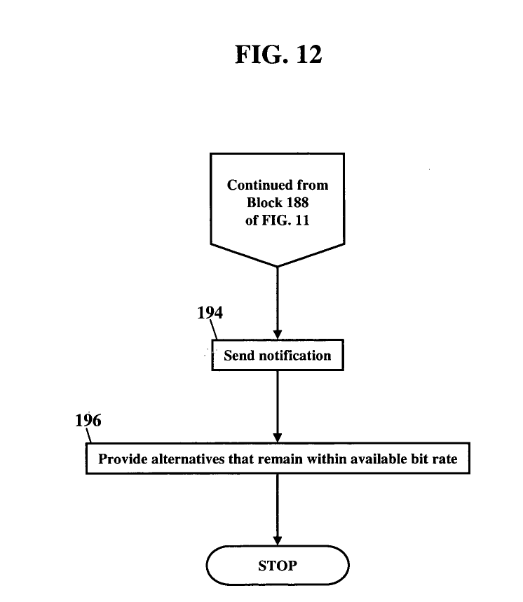

FIGS. 11 and 12 are flowcharts illustrating another method of providing communications services, according to exemplary embodiments. A maximum bit rate available between a first physical medium and a second physical medium is communicated (Block 180). The second physical medium is dynamically shared amongst multiple destinations to provide additional bandwidth. The maximum bit rate available may be communicated for the first physical medium, for the second physical medium, and/or for the combined bit rate of both physical mediums (Block 182). A request for data is received (Block 184), and the requested data has an associated bit rate. The bit rate of the requested data is compared to available bit rate (Block 186). If the requested bit rate is less than or equal to the available bit rate (Block 188), then the requested data is received via the first physical medium and/or via the second physical medium (Block 190). The requested data is then routed to a client device or destination (Block 192).

The flowchart continues with FIG. 12. When the requested bit rate exceeds the available bit rate (Block 188 of FIG. 11), then a notification is sent (Block 194). The notification causes a visual and/or physical prompt that informs a customer of a discrepancy between requested content/channels and available bandwidth. Alternatives may also be provided that remain within the available bit rate (Block 196).

The communications module 20 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the communications module 20 to be easily disseminated. A computer program product for expanding bandwidth includes the communications module 20 stored on the computer-readable medium. The communications module receives a request for communications services from a communications device. The communications module compares a bitrate of the requested communications services to the bandwidth of a first physical medium serving the communications device. If the bitrate of the requested communications services exceeds the available bandwidth of the first physical medium, then the communications module instructs a network device to logically bond a second physical medium to the communications device. The logically bonded second physical medium provides additional bandwidth to the communications device.

The communications module 20 may also be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of providing communications services, comprising the steps of:
receiving requested data via first physical medium and a second physical medium, the second physical medium dynamically shared amongst multiple destinations to provide additional bandwidth; and
routing the requested data to a client device.

2. A method according to claim 1, further comprising the step of communicating a combined maximum bit rate available between the first physical medium and the second physical medium.

3. A method according to claim 1, further comprising the step of communicating a maximum bit rate available via the first physical medium.

4. A method according to claim 1, further comprising the step of communicating a maximum bit rate available via the second physical medium.

5. A method according to claim 1, further comprising the step of comparing a requested bit rate to an available bit rate.

6. A method according to claim 5, wherein when the requested bit rate exceeds the available bit rate, then further comprising the step of sending a notification.

7. A method according to claim 5, wherein when the requested bit rate exceeds the available bit rate, then further comprising the step of providing an alternative that remains within the available bit rate.

8. A system, comprising:
a communications module stored in memory; and
a processor communicating with the memory,
the processor receiving requested data via first physical medium and a second physical medium, the second physical medium dynamically shared amongst multiple destinations to provide additional bandwidth; and
the processor routing the requested data to a client device.

9. A system according to claim 8, wherein the processor communicates a combined maximum bit rate available between the first physical medium and the second physical medium.

10. A system according to claim 8, wherein the processor communicates a maximum bit rate available via the first physical medium.

11. A system according to claim 8, wherein the processor communicates a maximum bit rate available via the second physical medium.

12. A system according to claim 8, wherein the processor compares a requested bit rate to an available bit rate.

13. A system according to claim 12, wherein when the requested bit rate exceeds the available bit rate, then the processor sends a notification.

14. A system according to claim 12, wherein when the requested bit rate exceeds the available bit rate, then the processor provides an alternative that remains within the available bit rate.

15. A computer program product, comprising:
a computer-readable medium; and
a communications module stored on the computer-readable medium, the communications module comprising computer instructions for
receiving requested data via first physical medium and a second physical medium, the second physical medium dynamically shared amongst multiple destinations to provide additional bandwidth; and
routing the requested data to a client device.

16. A computer program product according to claim 15, further comprising computer instructions for communicating a combined maximum bit rate available between the first physical medium and the second physical medium.

17. A computer program product according to claim 15, further comprising computer instructions for communicating i) a maximum bit rate available via the first physical medium and ii) a maximum bit rate available via the second physical medium.

18. A computer program product according to claim 15, further comprising computer instructions for comparing a requested bit rate to an available bit rate.

19. A computer program product according to claim 18, further comprising computer instructions for when the requested bit rate exceeds the available bit rate, then a notification is sent.

20. A computer program product according to claim 18, further comprising computer instructions for when the requested bit rate exceeds the available bit rate, then an alternative is provided that remains within the available bit rate.
